(19) United States
(12) Patent Application Publication
(10) Pub. No.: US 2015/0017037 A1
(43) Pub. Date: Jan. 15, 2015

(54) SEAL ARRANGEMENT

(71) Applicant: ElringKlinger AG, Dettingen (DE)

(72) Inventors: Klaus Hocker, Ilsfeld (DE); Walter Schuhmacher, Bietigheim-Bissingen (DE)

(73) Assignee: ElringKlinger AG

(21) Appl. No.: 14/497,895

(22) Filed: Sep. 26, 2014

Related U.S. Application Data
(63) Continuation of application No. PCT/EP2013/056679, filed on Mar. 28, 2013.

(30) Foreign Application Priority Data
Mar. 29, 2012 (DE) 102012102700.5

(51) Int. Cl. F16J 15/56; F04B 39/04

(52) U.S. Cl. CPC F16J 15/56; F04B 39/041
USPC 417/471; 277/407; 251/356

(57) ABSTRACT

A seal arrangement is provided for sealing a first medium from the environment or from a second medium, in a device having a movable element and a fixed element, wherein the movable element is configured for linear to-and-fro movement along a longitudinal axis and the fixed element forms a receptacle for the movable element. It is proposed that the seal arrangement should include a bellows having one or more layers made from a PTFE material, wherein the bellows at least partly receives the movable element, and wherein a first end region of the bellows is fastened in force-locking and sealing manner to the fixed element and a second end region of the bellows is fastened in force-locking and sealing manner to the movable element.

### CROSS-REFERENCE TO RELATED APPLICATIONS

The present application is a continuation of international application number PCT/EP2013/056679, filed on Mar. 28, 2013, which claims priority to German patent application number 10 2012 102 700.5, filed Mar. 29, 2012, the entire specification of both being incorporated herein by reference.

### FIELD OF THE INVENTION

The present invention relates to a seal arrangement for sealing a first medium from the environment or from a second medium, in a device having a movable element and a fixed element, wherein the movable element is configured for linear to-and-fro movement along a longitudinal axis and the fixed element forms a receptacle for the movable element.

### BACKGROUND OF THE INVENTION

Corresponding devices in which a seal of this kind is required are in particular piston pumps, such as high-pressure pumps for direct injection of petrol in internal combustion engines, or indeed various types of valves such as dispenser valves for drinks or other liquids. In principle, in the case of these devices the medium which is to be pumped, dispensed or transported must either be sealed from the environment or from a further medium, in particular a lubricant, in both the rest position of the movable element and during the to-and-fro movement thereof.

For this purpose, the seal arrangements known from the prior art include a lip seal which is arranged in a gap region between the movable element and the fixed element when the movable element is received in the fixed element. In this case, the lip seal is attached to the fixed element or the movable element and includes at least one sealing lip which abuts with a pretension against the respectively other element and slides along the surface thereof when the movable element moves to and fro. Typically, these lip seals are configured such that the force of pressure of the sealing lip against the surface, and thus the sealing effect, increase as a function of the pressure difference between the medium and the environment or between the two media.

Seal arrangements of this kind have the general disadvantage, however, that they cannot ensure 100% sealing even with an optimum configuration. Depending on the type of device, the operating conditions and wear to the lip seal as the operational period continues, leaks will always occur to a certain extent, that is to say a medium will seep out or be transferred into the environment or the respectively other medium. In particular for the medium having the higher pressure, in this context, each time the movable element moves, a thin film of medium will be drawn under the sealing lip and will then be partly stripped off during movement in the opposite direction and will reach the environment or the other medium.

In the case of high-pressure pumps for direct injection of petrol or diesel fuel, leaks of this kind are particularly critical, since either a transfer of fuel into the engine oil or indeed a transfer of engine oil into the fuel will be extremely disadvantageous, and must be reduced to the greatest possible extent for problem-free operation of the internal combustion engine. In the former case, dilution of the engine oil has an adverse effect on its lubricant effect, and in the latter case the transferred engine oil undergoes incomplete combustion, which can result in soot being deposited in particular on the valves.

A further disadvantage of lip seals is the wear that occurs, in particular in extreme conditions of use such as a significant pressure difference between the media and a high frequency of the movable element. It is specifically in the case of the high-pressure pumps mentioned above that the major pressure forces produce considerable heat of friction, with the result that even sealing lips made from relatively wear-resistant materials such as PTFE undergo considerable wear as the operational period continues. This in turn results in increasing leakage at the seal arrangement and, in the extreme case, even in complete failure.

The object of the present invention is thus to propose a seal arrangement in which these disadvantages are entirely or largely avoided.

### SUMMARY OF THE INVENTION

This object is achieved according to the invention in the case of the seal arrangement of the type mentioned in the introduction in that the seal arrangement includes a bellows having one or more layers made from a PTFE material, wherein the bellows at least partly receives the movable element, and wherein a first end region of the bellows is fastened in force-locking and sealing manner to the fixed element and a second end region of the bellows is fastened in force-locking and sealing manner to the movable element.

By providing a bellows in the seal arrangement according to the invention, it becomes possible to seal off hermetically the first medium from the environment or from the second medium. Leaks due to the system can thus be eliminated and the arrangement can be substantially entirely sealed, in particular since the sealing fastening of the end regions of the bellows, respectively to the fixed and movable elements, can be performed reliably and without problems by appropriate force locking. In contrast to a lip seal, in the invention there is no sliding movement of the sealing element—that is, the bellows—along the surface of the movable or the fixed element.

The to-and-fro movement of the two elements relative to one another is balanced out by the particular structure of the bellows, as known per se from the prior art. In the context of the present invention, the term “bellows” is understood to mean any substantially hollow-cylindrical element which, because of a folded, corrugated or similar wall structure, is capable of undergoing a flexible change in length along its longitudinal axis. In principle, the bellows may have any cross-sectional shape, with a circular cross-sectional shape being preferred, that is a rotationally symmetrical form of the bellows in respect of its longitudinal axis.

In a preferred embodiment of the invention, the device is a pump or valve, and the movable element is a piston or rod. Typically, the receptacle in the fixed element is of hollow-cylindrical form, with the result that there is an annular gap between the piston or rod and the inner wall of the receptacle.

The seal arrangement according to the invention is particularly suitable for piston pumps in which there is a large pressure difference between the two media and in which the piston performs a to-and-fro movement at high frequency and with a short stroke, such as a high-pressure pump for direct injection of petrol or diesel.

Valves in which the seal arrangement according to the invention may be used particularly advantageously are in particular filling valves for filling lines, aseptic valves or solenoid valves.

According to the invention, the bellows includes one or more layers made from a PTFE material. PTFE has a high resistance to heat and chemicals and for this reason is suitable for seal arrangements for the greatest variety of uses, in particular including contact with aggressive or reactive media. Moreover, the selection of suitable PTFE types may result in a high resistance to cyclic flexing, which is of particular significance for the wear resistance and service life of the bellows.

The PTFE material from which the layer(s) of the bellows is/are formed preferably comprises a homopolymer PTFE or a modified PTFE with a comonomer content of 0.1 weight % or less. Thus, the PTFE is either formed exclusively of tetrafluoroethylene units or comprises a small proportion of a comonomer which is also fluorinated. Modified PTFE has substantially the same properties as homopolymer PTFE; in particular (unlike PTFE copolymers, which have a higher comonomer content), it too is unsuitable for melt processing and has a high resistance to cyclic flexing. Preferably, the comonomer is a perfluoroalkyl vinyl ether, in particular perfluoropropyl vinyl ether (PPVE).

It is particularly favorable if the PTFE is a PTFE emulsion (E-PTFE) which was produced by the emulsion method. This is true both for homopolymer and for modified PTFE. PTFE emulsion may be extruded in the form of hoses or tubes by means of paste extrusion, and these hoses or tubes may then be used to produce a bellows by means of blow molding. This type of production is particularly advantageous, since it allows bellows having a variety of dimensions and geometries to be produced.

In the context of the invention, the PTFE material may be made entirely from PTFE, that is may have no further additives. As an alternative, however, it may also be provided for the PTFE material to include a filler, in particular a black pigment such as carbon black. The proportion of filler should not be selected to be too great, however, taking into account the possible reduction in the resistance to cyclic flexing, and should in particular not be greater than 5 weight %. Fillers for increasing the abrasion resistance of the PTFE are not required in the context of the invention, since there is no friction between the bellows and another element.

Preferably, the bellows is produced by means of blow molding. This production method is particularly advantageous in shaping the bellows, not only from the point of view of the possible variations already mentioned, but also from the point of view of the properties thereof, in particular the resistance to cyclic flexing. Preferably, the blow molding is performed on a blank which is paste-extruded from PTFE emulsion. To produce a multiple-layer bellows, two or more hoses or tubes made from the PTFE material may be pushed inside one another and then shaped into a bellows together by means of blow molding.

Bellows that are produced by means of a machining method, in particular of a PTFE suspension (S-PTFE), and which are known from the prior art for other areas of application, are not suitable for the seal arrangement according to the invention or are only suitable to a limited extent, since they do not typically have sufficient resistance to cyclic flexing. Similarly, producing the bellows from PTFE suspension by blow molding is problematic and is less preferable in the context of the invention.

If a bellows having only one layer of a PTFE material is used, the seal arrangement according to the invention is in principle completely functional and enables a hermetic seal, provided the bellows is undamaged. However, a bellows having two or more layers increases the operational reliability of the seal arrangement, and so is preferable. In the event of a tear or rupture in one of the layers, in this case a further layer is available to prevent leaks.

In an advantageous embodiment of the invention, the bellows includes two layers which are welded to one another in the end regions. This welding may be performed during production of the bellows by means of blow molding, by pressing the end regions of the two hoses or tubes which are pushed inside one another together using a holding tool and then heating them to perform the blow molding.

A bellows having two or more layers is arranged in the device (that is, in a pump or valve, for example) such that the first medium, which is at a higher pressure than the environment or the second medium, is located inside the bellows, or in the intermediate space between the movable element and the bellows. In this case, the two layers of the bellows may be formed to have the same thickness, or the inner layer may be thicker, since it is directly exposed to the first medium.

In the case of a bellows having two layers, a pressure sensor may be arranged between the two layers. A sensor of this kind can detect damage to the inner layer immediately and emit a corresponding warning, since if the first medium passes through a tear or rupture in the inner layer, the pressure between the two layers will increase dramatically. This is particularly significant in the case of a high-pressure pump for direct injection of fuel, since without a sensor of this kind a leak here will not be noticed directly but can have serious consequences if operation continues.

In order to achieve a force-locking and sealing fastening of the end regions of the bellows to the fixed and the movable element, the end regions are preferably clamped, braced or screwed. Here, it is possible for the end regions to be subject to a radial and/or axial force in relation to the longitudinal axis of the movable element and the bellows.

In a further advantageous embodiment of the invention, the seal arrangement includes metal reinforcement rings which surround the bellows on the outside and are each arranged in a fold of the bellows. Reinforcement rings of this kind may counter the force exerted by the first medium on the bellows from the inside. If the bellows is produced by means of blow molding, the metal reinforcement rings are arranged on the blank beforehand, before it is shaped into a bellows.

As an alternative or in addition to the reinforcement rings, a similar reinforcing function may also be achieved in that the seal arrangement includes a supporting hose that surrounds the bellows on the outside. A supporting hose of this kind is preferably formed from a particularly tear-resistant material, for example a glass fiber braid.

The options described above for reinforcing the bellows from the action of pressure on the inside are particularly significant in those embodiments of the invention in which the first medium is located both in the receptacle in the fixed element and in the intermediate space between the movable element and the bellows. In this case, the bellows is the only sealing element of the seal arrangement according to the invention.

In the event of relatively great pressure differences between the first medium and the environment or the second medium, however, it may be advantageous if the bellows is at least partly relieved of the pressure of the first medium. According to a further preferred embodiment of the invention, it is therefore provided for the seal arrangement further to include a lip seal for sealing the first medium from the intermediate space between the movable element and the bellows. A lip seal of this kind prevents the first medium, which is in the receptacle in the fixed element, from filling up the interior of the bellows at its full pressure and acting thereon at high pressure on the inside. It is true that, because of the disadvantages of lip seals described in the introduction, certain quantities of the first medium will penetrate the bellows as a result of leaks, but this is not critical, since a hermetic seal from the environment or the second medium is in all cases ensured by the bellows.

Preferably, the lip seal is fastened to the fixed element or the movable element and includes at least one sealing lip which abuts with a pretension against the respectively other element. The at least one sealing lip is preferably made from PTFE, a fluoropolymer suitable for melt processing, or a compound of these polymers with one or more fillers. The pretension may be obtained from the material of the sealing lip itself, in particular using the memory effect of PTFE, and/or from a spring element made from steel.

If the seal arrangement according to the invention includes a lip seal of this kind, it is further preferable if the seal arrangement includes a fluid line for removing the first medium from the intermediate space between the movable element and the bellows. The fluid line may be used to return the first medium in particular to a corresponding reservoir, in the case of an injection pump for example a fuel tank. This prevents the intermediate space between the movable element and the bellows from filling completely with the first medium after a certain period of operation and a corresponding pressure from building up.

Further, the present invention relates to a high-pressure pump for direct injection of fuel in an internal combustion engine, including a seal arrangement according to the invention, wherein the first medium is a fuel (in particular petrol or diesel fuel) and the second medium is a lubricant (in particular engine oil), and wherein the movable element is a piston driven by a camshaft. High-pressure pumps of this kind are typically operated at a piston frequency of up to 250 Hz and a piston stroke of from 2 to 10 mm, with the pressure of the fuel typically being around 6 bar (with pressure peaks of up to 40 bar) and the pressure of the lubricant being at most 1 bar. The temperature of the fuel is up to 110° C., and the temperature of the lubricant is up to 130° C.

The particular advantages of the high-pressure pump according to the invention, that is in particular hermetically sealing the fuel from the lubricant and the higher wear resistance of the bellows by comparison with a lip seal, have already been described in detail in conjunction with the seal arrangement according to the invention. Preferably, a bellows for a high-pressure pump according to the invention is from 10 to 30 mm long, has a minimum internal diameter of 5 to 12 mm and has walls from 0.1 to 1.0 mm thick.

Furthermore, the invention also relates to a dispenser valve for a filling line for drinks, including a seal arrangement according to the invention, wherein the first medium is a drink to be dispensed. In lines of this kind, drinks are in some cases dispensed under high pressure and at high temperatures, with the result that high demands are made of the seal arrangement here as well. Typical operating conditions are for example a valve stroke of 12 mm, a frequency of 20 Hz, a pressure of up to 8 bar and a temperature of up to 120° C. Here too, the seal arrangement must have sufficient resistance to the cleaning and sterilization agents used.

These and further advantages of the invention will be explained in more detail by way of the exemplary embodiments below, with reference to the Figures.

### BRIEF DESCRIPTION OF THE DRAWINGS

In the individual Figures:

FIG. 1 shows a cross-sectional illustration of a first exemplary embodiment of a seal arrangement according to the invention; and

FIG. 2 shows a cross-sectional illustration of a second exemplary embodiment of a seal arrangement according to the invention.

### DETAILED DESCRIPTION OF EMBODIMENTS OF THE INVENTION

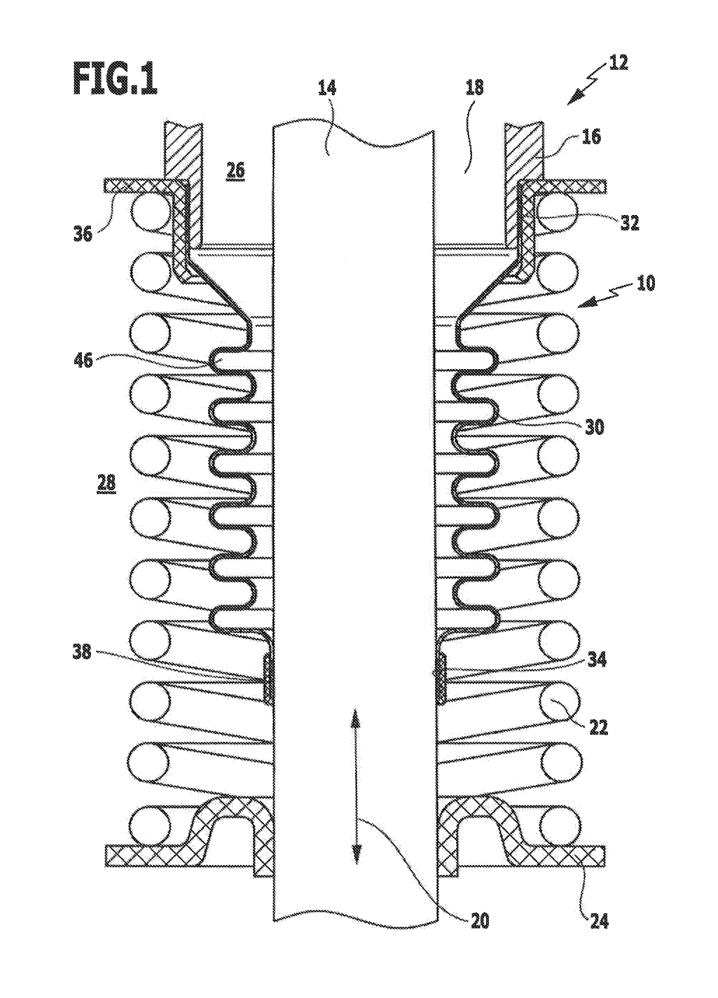

FIG. 1 shows a cross section through a first exemplary embodiment of a seal arrangement 10 according to the invention, as a component of a device 12, which is illustrated only in part. The device 12 is in this case a piston pump having a movable element 14 in the form of a piston and a fixed element 16 which forms a receptacle 18 for the piston 14.

When the piston pump 12 is operated, the piston 14 performs a linear to-and-fro movement along its longitudinal axis 20. During this, the piston 14 is on each occasion moved in the direction of the receptacle 18 by a drive element (such as a camshaft) which is not shown in the Figure, while the opposing movement is brought about by a spring 22. The spring 22 is supported at one end against the fixed element 16 and at the other against an opposing plate 24.

In the piston pump 12, the first medium 26 which is to be pumped is located in the receptacle 18 of the fixed element 16 inter alia, and a second medium 28, which is in particular a lubricant, is located in the region below the fixed element 16. The first medium 26 is at a higher pressure than the second medium 28.

In order to seal the first medium 26 from the second medium 28, the seal arrangement 10 according to the invention includes a bellows 30 which is made from a PTFE material and partly receives the piston 14. The bellows 30 is illustrated as being in one layer in FIG. 1, but as an alternative it may also be formed in multiple layers, in particular in two layers.

The PTFE material from which the bellows 30 is formed preferably comprises a homopolymer PTFE or a modified PTFE having a comonomer content of 0.1 weight % or less, wherein it is in particular a PTFE emulsion.

The bellows 30 is fastened, in force-locking and sealing manner, to the fixed element 16 by means of its first end region 32 and to the piston 14 by means of its second end region 34. In this arrangement, it is fastened to the fixed element 16 by means of a clamping element 36 and to the piston 14 by means of a clamping ring 38, in each case by radial force being applied to the end regions 32 and 34 of the bellows 30 in relation to the longitudinal axis 20.

During the to-and-fro movement of the piston 14, the bellows 30 can change length flexibly, as a result of its folded or corrugated wall structure. In this way, a hermetic and leak-free seal between the first medium 26 and the second medium 28 is made possible by the seal arrangement 10 according to the invention.

The piston pump 12 may in particular be a high-pressure pump for direct injection of fuel in an internal combustion engine. However, seal arrangements having the same or a similar construction may also be used in other pumps or in valves.

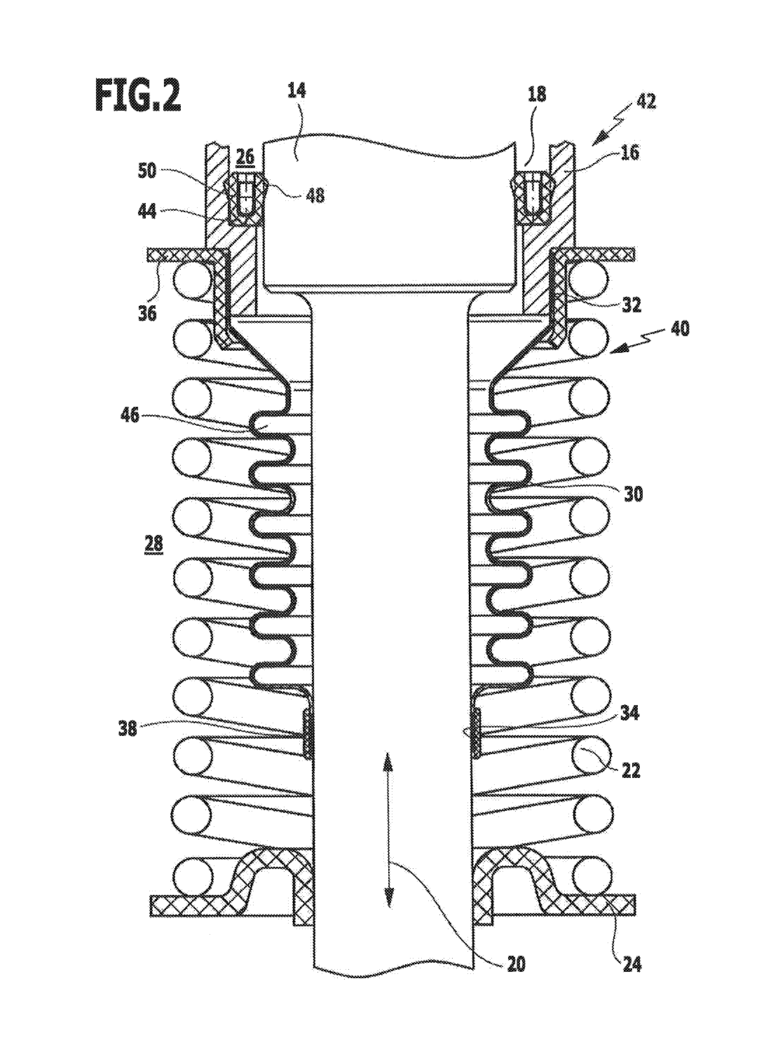

FIG. 2 shows a cross section through a second exemplary embodiment of a seal arrangement 40 according to the invention, as a component of a device 42. This exemplary embodiment corresponds to the first exemplary embodiment according to FIG. 1 apart from the differences described below, and like or equivalent elements are in each case provided with the same reference numeral.

The seal arrangement 40 additionally includes a lip seal 44 which is arranged in the annular gap between the inner wall of the receptacle 18 and the piston 14. This lip seal 44 serves to seal the first medium 26, which is in the receptacle 18, from the intermediate space 46 between the piston 14 and the bellows 30. This prevents the bellows 30 from being acted upon by the high pressure of the first medium 26 on the inside.

The lip seal 44 is fastened to the fixed element 16 and includes a sealing lip 48 which abuts with a pretension against the piston 14. This pretension is generated by a steel spring 50 which has a U-shaped profile and is laid inside the lip seal 44. As the pressure of the first medium 26 increases, acting on the sealing lip 48, the force of pressure against the piston 14 and hence the sealing action are intensified further.

As an alternative to the embodiment of the lip seal 44 which is illustrated in FIG. 2, a multiplicity of further embodiments are possible, for example a lip seal having two sealing lips which are oriented in opposite directions in relation to the longitudinal axis 20. With one or more sealing lips it is also possible to dispense with a spring element, in which case the pretension is generated by a memory effect of the material of the sealing lip. This is in particular a material made from PTFE, or a fluoropolymer which is suitable for melt processing, or a corresponding compound.

Because of leaks at the lip seal 44, in particular as a result of wear as the operational period of the device 42 increases, small quantities of the first medium 26 may still reach the intermediate space 46. In order to avoid pressure building up in the intermediate space 46, a fluid line (not illustrated in the Figure) may be provided in order to remove the first medium 26 from the intermediate space 46 and to feed it to a corresponding reservoir (for example a fuel tank, in the case of an injection pump).

1. A seal arrangement for sealing a first medium from the environment or from a second medium, in a device having a movable element and a fixed element, wherein the movable element is configured for linear to-and-fro movement along a longitudinal axis and the fixed element forms a receptacle for the movable element, wherein the seal arrangement includes a bellows having one or more layers made from a PTFE material, wherein the bellows at least partly receives the movable element, and wherein a first end region of the bellows is fastened in force-locking and sealing manner to the fixed element and a second end region of the bellows is fastened in force-locking and sealing manner to the movable element.

2. The seal arrangement according to claim 1, in which the device is a pump or valve, and the movable element is a piston or rod.

3. The seal arrangement according to claim 1, in which the PTFE material comprises a homopolymer PTFE or a modified PTFE with a comonomer content of 0.1 weight % or less.

4. The seal arrangement according to claim 3, in which the PTFE is a PTFE emulsion.

5. The seal arrangement according to claim 1, in which the PTFE material includes a filler, in particular a black pigment.

6. The seal arrangement according to claim 1, in which the bellows is produced by means of blow molding.

7. The seal arrangement according to claim 1, in which the bellows includes two layers which are welded to one another in the end regions.

8. The seal arrangement according to claim 7, in which a pressure sensor is arranged between the two layers.

9. The seal arrangement according to claim 1, in which, in order to achieve force-locking and sealing fastening to the fixed and the movable element, the end regions of the bellows are clamped, braced or screwed.

10. The seal arrangement according to claim 1, in which the seal arrangement includes metal reinforcement rings which surround the bellows on the outside and are each arranged in a fold of the bellows.

11. The seal arrangement according to claim 1, in which the seal arrangement includes a supporting hose that surrounds the bellows on the outside.

12. The seal arrangement according to claim 1, in which the first medium is located both in the receptacle in the fixed element and in the intermediate space between the movable element and the bellows.

13. The seal arrangement according to claim 1, in which the seal arrangement further includes a lip seal for sealing the first medium from the intermediate space between the movable element and the bellows.

14. The seal arrangement according to claim 13, in which the lip seal is fastened to the fixed element or the movable element and includes at least one sealing lip which abuts with a pretension against the respectively other element.

15. The seal arrangement according to claim 14, in which the seal arrangement includes a fluid line for removing the first medium from the intermediate space between the movable element and the bellows.

16. A high-pressure pump for direct injection of fuel in an internal combustion engine, including a seal arrangement according to claim 1, in which the first medium is a fuel and the second medium is a lubricant, and in which the movable element is a piston driven by a camshaft.

17. A dispenser valve for a filling line for drinks, including a seal arrangement according to claim 1, in which the first medium is a drink to be dispensed.
